(19) United States
(12) Patent Application Publication
(10) Pub. No.: US 2024/0092511 A1
(43) Pub. Date: Mar. 21, 2024

(54) UNMANNED DEPLOYED DROGUE ENERGY RECOVERY

(71) Applicant: GEORGIA TECH RESEARCH CORPORATION, Atlanta, GA (US)

(72) Inventor: Evan David Hammac, Atlanta, GA (US)

(21) Appl. No.: 18/267,149

(22) PCT Filed: Jan. 4, 2022
(86) PCT No.: PCT/US2022/011113

§ 371 Date: Jun. 14, 2023

Related U.S. Application Data
(60) Provisional application No. 63/133,536, filed on Jan. 4, 2021.

(51) Int. Cl. B64U 50/34; B64D 27/351

(52) U.S. Cl. CPC B64U 50/34; B64D 27/351

(57) ABSTRACT

An exemplary rapid electrical charging system is disclosed for autonomous electrical vehicle refueling. The system can be used for in-air refueling, on-the-ground refueling, and refueling application. The system employs a charging and disconnects circuit and associated connection hardware at the autonomous electric vehicle and the charging vehicle to facilitate fast charging of the autonomous electrical vehicle while the battery system of the autonomous electrical vehicle is in use. The rapid electrical charging system located on the charging vehicle can optimally (i) power the aircraft systems of the autonomous electrical vehicle, (ii) transfer power to the onboard battery of the autonomous electric vehicle while isolating the battery from the onboard loads, and (iii) subsequently transition the autonomous electrical vehicle to its onboard battery power. The rapid electrical charging system may include a secondary charging circuit to charge/balance individual cell of the onboard battery.

### RELATED APPLICATION

This PCT application claims priority to, and the benefit of, U.S. Provisional Patent Application No. 63/133,536, filed Jan. 4, 2021, entitled “Unmanned Deployed Drogue Energy Recovery,” which is incorporated by reference herein in its entirety.

### TECHNICAL FIELD

The present disclosure generally relates to methods and systems for charging an electric vehicle, specifically, an aerial electric vehicle using an unmanned deployed drogue.

### BACKGROUND

Current in-air refueling uses large tanker aircraft and pumps liquid fuel to accomplish a persistent aerial presence. Tanker jets deploy a drogue behind them while pilots steer a refueling probe into the drogue. Autonomous refueling with liquid fuel exists, yet with the rise of small unmanned aerial systems (sUASs) and unmanned aerial systems (UASs) that rely on electrical propulsion, liquid in air refueling is not an option.

There is a technical benefit to duplicating this capability with electrically powered sUAS and UAS and addressing current limitations therewith.

### SUMMARY

An exemplary rapid electrical charging system is disclosed for autonomous electrical vehicle refueling. The system can be used for in-air refueling, on-the-ground refueling, and refueling application. The system employs a charging and disconnects circuit and associated connection hardware at the autonomous electric vehicle and the charging vehicle to facilitate fast charging of the autonomous electrical vehicle while the battery system of the autonomous electrical vehicle is in use. The rapid electrical charging system located on the charging vehicle can optimally (i) power the aircraft systems of the autonomous electrical vehicle, (ii) transfer power to the onboard battery of the autonomous electric vehicle while isolating the battery from the onboard loads, and (iii) subsequently transition the autonomous electrical vehicle to its onboard battery power. The rapid electrical charging system may include a secondary charging circuit to charge/balance individual cell of the onboard battery.

In an aspect, a method is disclosed comprising providing a refueling harness from a charging aerial vehicle, the refueling harness comprising a first set of two or more conductors and a second set of two or more conductors that terminate at a set of open terminals on a drogue, wherein the first set of two or more conductors is configured to carry electrical energy to refuel one or more electrical energy storage components located on an aerial vehicle (e.g., unmanned aerial vehicle), and wherein the second set of two or more conductors is configured to carry electrical energy to electrical loads of the aerial vehicle; connecting, via the drogue, over the first set of two or more conductors, a charger circuit of the charging aerial vehicle to a first electrical bus of the aerial vehicle that connects to the one or more electrical energy storage; and connecting, via the drogue, over the second set of two of more conductors, a first power supply of the charging aerial vehicle to a second electrical bus of the aerial vehicle that connects to the electrical loads of the aerial vehicle.

In some embodiments, the method further includes sensing, by sensing circuitry (e.g., of the aerial vehicle), a connection between (i) two or more terminals of the second set of two or more conductors and (ii) second power supply of the aerial vehicle, wherein the second power supply connects to the electrical loads; and disconnecting, by a power circuitry, based on the sensing, a third bus connection between (i) the second power supply located on the aerial vehicle and (ii) the one or more electrical energy storage.

In some embodiments, the second power supply of the aerial vehicle is connected to the one or more electrical energy storage of the aerial vehicle, and wherein electrical power is not drawn from the one or more electrical energy storage when the second electrical bus is disconnected.

In some embodiments, the method further includes sensing, by the sensing circuitry, a disconnection between (i) at least one of the two or more terminals of the second set of two or more conductors to terminals connected and (ii) the second power supply of the aerial vehicle; and re-connecting, by the power circuitry, based on the sensing, the third electrical bus connecting between (i) the second power supply of the aerial vehicle and (ii) the electrical loads of the aerial vehicle.

In some embodiments, the method further includes sensing voltage level of individual cells of the onboard battery; and balance charging one of more of the individual cells based on the sensing.

In some embodiments, the aerial vehicle is an unmanned aerial vehicle.

In some embodiments, the aerial vehicle is a terrestrial or surface/underwater-based vehicle.

In another aspect, a refueling harness is disclosed for a charging aerial vehicle, the refueling harness comprising a drogue that connects to an end of the refueling harness; a first set of two or more conductors that terminate at a first set of open terminals on a drogue, wherein the first set of two or more conductors is configured to carry electrical energy from a charging circuit of the charging aerial vehicle to refuel one or more electrical energy storage components located on an aerial vehicle; and a second set of two or more conductors that terminates at a second set of open terminal on the drogue, wherein the second set of two or more conductors is configured to carry electrical energy from a first power supply of the charging aerial vehicle to electrical loads of the aerial vehicle, wherein a second power supply of the aerial vehicle is connected to the one or more electrical energy storage of the aerial vehicle, and wherein electrical power of the one or more electrical energy storage of the aerial vehicle is not drawn from the one or more electrical energy storage when a first electrical bus is connected between the first set of two or more conductors and the one or more electrical energy storage components.

In some embodiments, the harness includes a third set of a plurality of conductors that terminates at a third set of the open terminal on the drogue, wherein the third set of the plurality of conductors is configured to carry electrical energy from the second power supply individual cells of the one or more electrical energy storage of the aerial vehicle.

In some embodiments, a third bus connection is disconnected between (i) the second power supply located on the aerial vehicle and (ii) the one or more electrical energy storage when the aerial vehicle is electrically connected to the drogue.

In some embodiments, the third bus connection is disconnected by sensing, by a sensing circuitry of the aerial vehicle, a connection between (i) two or more terminals of the second set of two or more conductors to terminals connected and (ii) second power supply of the aerial vehicle; and disconnecting, by a power circuitry, based on the sensing, a third bus connection between (i) the second power supply located on the aerial vehicle and (ii) the one or more electrical energy storage.

In another aspect, an aerial vehicle is disclosed comprising one or more electrical energy storage components; a first power supply configured to provide electrical energy to electrical loads of the aerial vehicle; and a rapid electrical charging system. The rapid electrical charging system includes an electrical port configured to couple to an external refueling harness comprising a drogue while the aerial is in-flight; a first set of two or more conductors that terminate at the electrical port, wherein the first set of two or more conductors is configured to carry electrical energy from a charging circuit of a charging aerial vehicle to refuel the one or more electrical energy storage components; and a second set of two or more conductors that terminates at the electrical port, wherein the second set of two or more conductors is configured to carry electrical energy from a first power supply of the charging aerial vehicle to the electrical loads of the aerial vehicle, wherein a second power supply of the aerial vehicle is connected to the one or more electrical energy storage of the aerial vehicle, and wherein electrical power of the one or more electrical energy storage of the aerial vehicle is not drawn from the one or more electrical energy storage when the second set of two or more conductors is connected to the drogue.

In some embodiments, the aerial vehicle includes a disconnection circuit configured to (i) sense, by a sensing circuitry of the aerial vehicle, a connection between (a) two or more terminals of the second set of two or more conductors and (b) second power supply of the aerial vehicle and (ii) disconnect, by a power circuitry, based on the sensing, a third bus connection between (a) the second power supply of the aerial vehicle and (b) the electrical loads of the aerial vehicle.

In some embodiments, the power circuitry comprises an IGBT or a MOSFET. In some embodiments, the power circuitry includes a microcontroller.

In some embodiments, the disconnection circuit is configured to isolate the one or more electrical energy storage components from the electrical loads of the aerial vehicle so as to prevent electrical power from being drawn from the one or more electrical energy storage.

In some embodiments, the disconnection circuit is configured to (i) sense, by the sensing circuitry, a disconnection between (a) at least one of the two or more terminals of the second set of two or more conductors to terminals connected and (b) the second power supply of the aerial vehicle and (ii) re-connect, by the power circuitry, based on the sensing, the third electrical bus.

In some embodiments, the disconnection circuit includes a first sensing circuit, a second sensing circuit, a first control output, and a second control output, wherein the first sensing circuit is configured to sense voltage at the second set of two or more conductors, wherein the second sensing circuit is configured to sense voltage at a bus connected to the one or more electrical energy storage components, and wherein the disconnection circuit is configured, by instructions or circuitry, to enable a switch to connect the second power supply of the aerial vehicle to the one or more electrical energy storage of the aerial vehicle based on the first and second sensing.

In some embodiments, the disconnection circuit is configured to connect the power supply of the charging aerial vehicle to the electrical loads of the aerial vehicle when the voltage sensed at the second sensing circuit meets an overvoltage (OV) and under-voltage (UV) window for a pre-defined validation time.

In some embodiments, the disconnection circuit is configured to immediately (i) disconnect the third bus connection and (ii) connect the bus connected to the one or more electrical energy storage components when the voltage sensed at the second sensing circuit exceeds the overvoltage (OV) or the under-voltage (UV) window.

In some embodiments, the second power supply is configured to (i) sense voltage level of individual cells of the onboard battery and (ii) balance charge one of more of the individual cells based on the sensing.

### BRIEF DESCRIPTION OF THE DRAWINGS

The skilled person in the art will understand that the drawings described below are for illustration purposes only.

FIG. 1 shows a diagram of an example rapid electrical charging system for an aerial vehicle such as a small unmanned aerial system (sUAS) or an unmanned aerial system (UAS) and a charging vehicle in accordance with an illustrative embodiment.

FIG. 2 shows an example circuit diagram of the disconnection circuit in accordance with an illustrative embodiment.

FIGS. 3A and 3B show example operations of the disconnection circuit of FIG. 2 in accordance with an illustrative embodiment.

FIGS. 4A-4D show an experimental setup to evaluate the rapid electrical charging system of FIG. 1 in accordance with an illustrative embodiment.

### DETAILED SPECIFICATION

Each and every feature described herein, and each and every combination of two or more of such features, is included within the scope of the present invention provided that the features included in such a combination are not mutually inconsistent.

Some references, which may include various patents, patent applications, and publications, are cited in a reference list and discussed in the disclosure provided herein. The citation and/or discussion of such references is provided merely to clarify the description of the present disclosure and is not an admission that any such reference is “prior art” to any aspects of the present disclosure described herein. In terms of notation, “[n]” corresponds to the n^{th} reference in the list. All references cited and discussed in this specification are incorporated herein by reference in their entireties and to the same extent as if each reference was individually incorporated by reference.

Example System

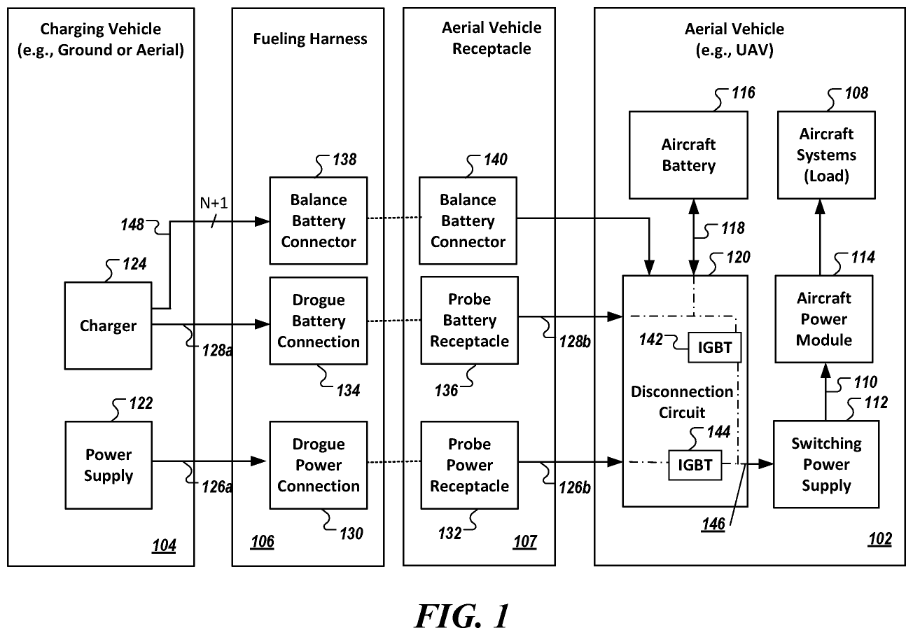

FIG. 1 shows a diagram of an example rapid electrical charging system 100 for an aerial vehicle 102 such as a small unmanned aerial system (sUAS) or an unmanned aerial system (UAS) and a charging vehicle 104 in accordance with an illustrative embodiment. The aerial vehicle 102 and charging vehicle 104 are connected over a fueling harness 106.

In the example shown in FIG. 1, the aerial vehicle 102 includes aircraft systems 108 that serve as electrical loads that are connected through the power bus 110 and powered by a switching power supply 112, connected through an aircraft power module 114. The aircraft power module 114 is an auxiliary battery module that can provide ride-through capabilities in the event of a momentary or sustained loss of aircraft bus power. The switching power supply 112 is connected to the aircraft battery 116 through a battery bus 118.

The rapid electrical charging system 100 includes a disconnection circuit 120 that connects the switching power supply 112 to the aircraft battery 116. The disconnection circuit 120 facilitate a more optimal charging and control of the charging of the aircraft on-board battery 116 by isolating the aircraft battery 116 from the on-board loads of the aerial vehicle 102. This optimal charge reduces the strain that is placed on the batteries during charging that can extend the operational life of the aircraft battery 116. The disconnection circuit 120 is configured to (i) sense when both the aircraft battery is being charged and that a separate switching power source is available through the fueling harness 106 and (ii) disconnect the switching power supply 112 from the aircraft battery 116. The disconnection circuit 120 includes a set of switches shown as a first switch 142 (shown as “IGBT” 142) and a second switch 144 (shown as “IGBT 144) that, respectively, connect/disconnect the aircraft battery 166 to a common bus 146 connected to the switching power supply 112 and connect/disconnect the charging vehicle power supply 104 to the common bus 146. The switches can be a MOSFET, an IGBT, a transistor, or a combination thereof. The set of switches may include a microcontroller or a control or driver circuit. In other embodiments, the set of switches are power devices that are driven by driver circuit integrated into the disconnection circuit 120 or other connected module. During fast charging operation, the disconnection circuit 120 disconnects the aircraft battery 116 from the common bus 146 to the switching power supply 112 and connects the charging vehicle power supply 104 to the common bus 146. In non-charging mode, the disconnection circuit 120 connects the aircraft battery 116 to the common bus 146 and the switching power supply 112 and disconnects the charging vehicle power supply 104 to the common bus 146.

In the example shown in FIG. 1, charging vehicle 104 includes a power supply 122 and a charger 124 that connect, over separate power connections 126 and 128, over the fueling harness 106, to the switching power supply 112 and aircraft battery 116. The separate power supply 122, charger 124, and power connections 126, 128 allow for flexibility in the control of the charging of the aircraft battery 116 while allowing the aircraft systems 108 to draw power entirely, or mostly entirely, from the switching power supply 112 powered by the power supply 112 of the charging vehicle 122.

Fueling harness 106 includes a drogue connection for the power bus 126 (shown as 126a and 126b) and the battery bus 128 (shown as 128a and 128b). The power bus 126a of the charging vehicle terminates at a drogue power connection 130 that connects to a probe power terminal 132 (also referred to herein as the “probe power receptacle” 132) located in the receptable 107 of the aerial vehicle. The probe power receptacle 132 connects over the power bus 126b to the switching power supply 112. the refueling harness 106, in some embodiments, includes a first set of two or more conductors and a second set of two or more conductors that terminate at a set of open terminals on a drogue.

The power bus 128a of the charging vehicle terminates at a drogue battery connection 134 that connects to a probe battery terminal 136 (also referred to herein as the “probe battery receptacle” 136) located in the receptable 107 of the aerial vehicle. The probe battery receptacle 136 connects over the power bus 128b to the aircraft battery 116.

In the example shown in FIG. 1, the fueling harness 106 also includes a third set of conductors (shown as cables 148) for balance battery connection that terminates at balance battery connector 138 to connect with the terminal 140 in the receptable 107 located at the aerial vehicle.

The balance battery connectors can include N+1 number of small connections that connects to a set of smaller gauge conductors in which N corresponds to the number of individual cells of the battery. The additional wire (N+1^{th}) can be for the ground. In some embodiments, there can be 2N balance battery conductors, a first set for sensing and a second set for charging. The balance charging operation allows for individual cells or sub-set of the cells of the batteries to be sensed/measured and for their individual cells to be additionally charged by this secondary charging operation while the primary charging is on-going between the charging vehicle charger 124 and the aircraft battery 116 through the battery bus 128. State of charge unbalance can result when cells have charges or are charged to different state of charge (SOC) levels that can be attributed to impedance difference among the cells, e.g., due to variations in the manufacturing process of the cell. The balance charging circuit can sense and apply higher voltages to individual cells as compared to other cells so those cells that are unbalanced can be made balanced. An example circuit operation is described in Yevgen Barsukov, “Battery Cell Balancing: What to Balance and How,” published by Texas Instrument, which is incorporated by reference herein in its entirety.

The harness 106 and receptable 107 may include additional control wiring (e.g., digital communication lines, status lines), ground wires, and insulation (not shown).

Example Implementation of the Disconnection Circuit

As noted above, the disconnection circuit 120 connects the switching power supply (e.g., 112) to the aircraft battery (e.g., 116) and is configured to (i) sense when both the aircraft battery is being charged and that a separate switching power source is available through the fueling harness 106 and (ii) disconnect the switching power supply 112 from the aircraft battery 116.

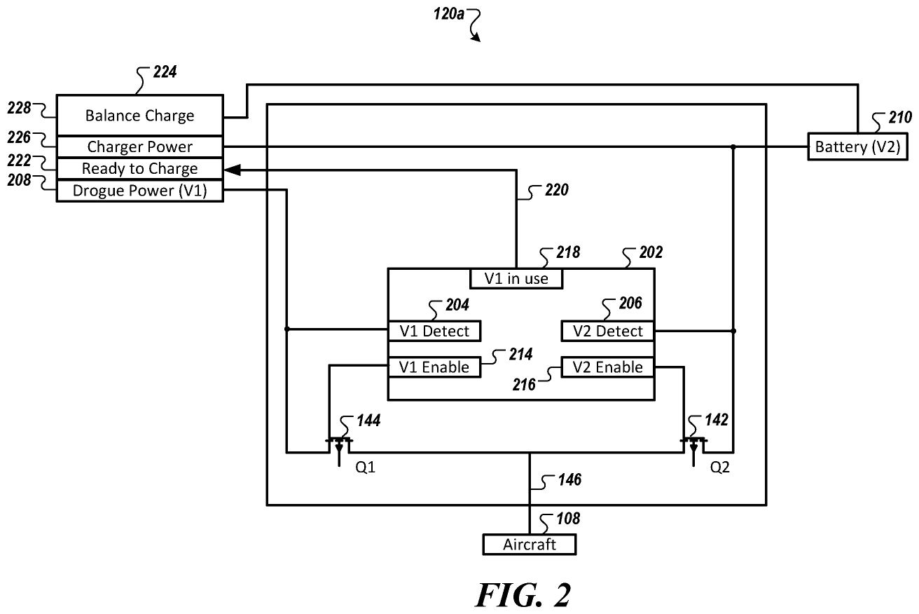

FIG. 2 shows an example circuit diagram of the disconnection circuit 120 (shown as 120a) in accordance with an illustrative embodiment. The disconnection circuit 120 is configured with a controller 202 that can connect two valid power supplies, namely, the aircraft battery (e.g., 116) and the charging vehicle power supply (e.g., 122) to a common output (e.g., the aircraft systems load 108) based on priority and validity. Priority can be defined by pin assignment, with the designated “V1” supply assigned the higher priority and the “V2” supply assigned the lower priority. A power source is defined as valid when its voltage is sensed continuously to be within its overvoltage (OV) and under-voltage (UV) window for a prescribed validation time. If the highest priority valid input falls out of the OV/UV window, the channel is immediately disconnected, and the other valid input is connected to the common output.

In the example shown in FIG. 2, controller 202 includes a “V1” sensing port 204 (shown as “V1 Detect” 204) and a “V2” sensing port 206 (shown as “V2 Detect” 206). The controller 202 further includes a V1 enable port 214, and a V2 enable port 216. The “V1” sensing port 204 is connected to a drogue power (V1) terminal 208 that connects to the power bus 126b. The “V2” sensing port 206 is connected to a battery (V2) terminal 210 that connects to the power bus 118 and the aircraft battery 116. and the charging vehicle power supply 104.

The controller 202 includes a “V1” enable port 214 and a “V2” enable port 216. The “V1” enable port 214 is connected to switch 144 that connects/disconnects the drogue power (V1) terminal 208 connected to the charging vehicle power supply 104 to the common bus 146. The “V2” enable port 216 is connected to switch 142 that connects/disconnects the battery (V2) terminal 210 connected to the aircraft battery 116 through the common bus 146. In the example shown in FIG. 2, the controller 202 includes a status port 218 (shown as “V1 in use” 218) that provides a signaling output 220 to the charging aircraft 104 through a charger power status terminal 222 (shown as “Ready to charge” 222) that the power supply 104 is selected for use. In other embodiments, the “V2” enable port 214 may be used to provide the signaling (e.g., 220). The charger power status terminal 222 and V1 enable port 208 may be integrated into a single terminal 224. Terminal 224 may include a charger power terminal 226 that connects to the battery bus 118a and to the to the battery (V2) terminal 210. Terminal 224 may include a balance charge terminal 228 that connects to the charge balance cable 148 and to the to the battery (V2) terminal 210.

An example of the controller 202 is the Dual Channel Prioritized PowePath Controller LTC 4418 (manufactured by Analog Devices, Wilmington, MA). In some embodiments, the disconnection circuit (e.g., 202) can be miniaturized to provide installation in the smallest of UAS and decrease the overall weight of the system.

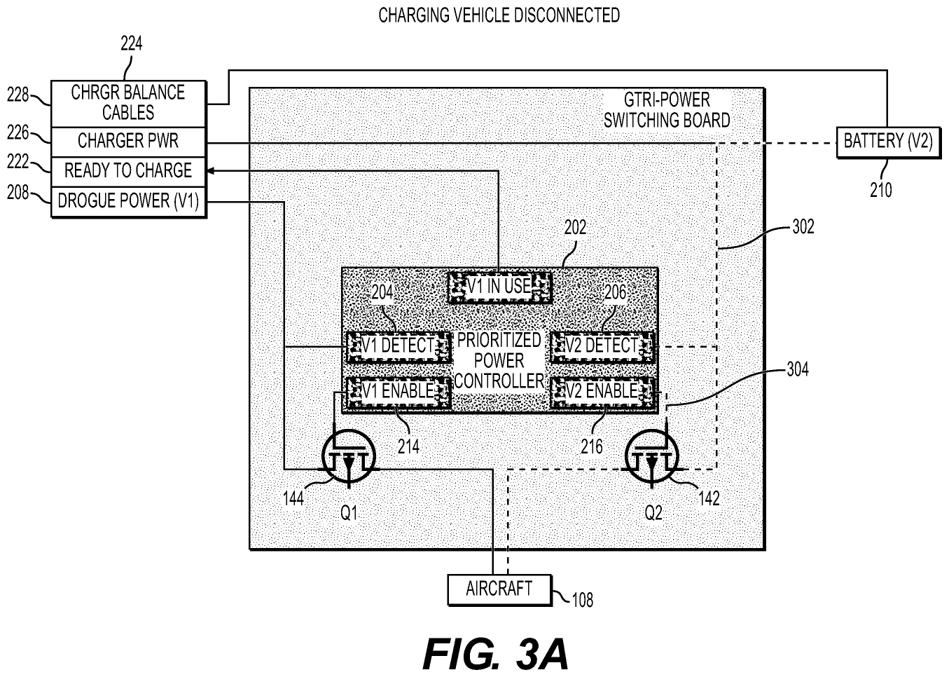

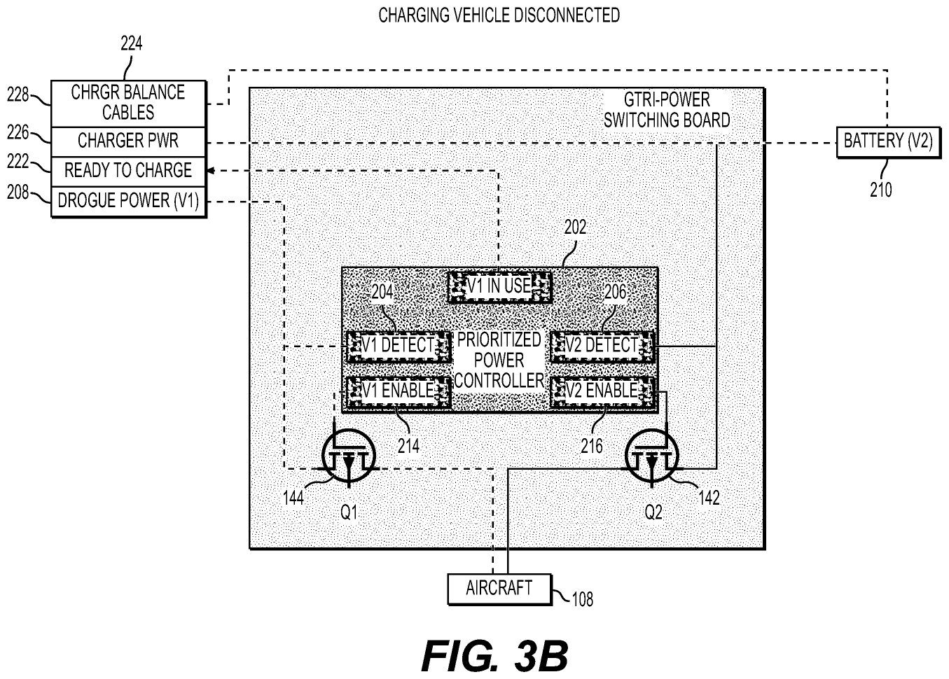

FIGS. 3A and 3B show example operations of the disconnection circuit 120a of FIG. 2 in accordance with an illustrative embodiment.

Pre- or Non-Charging Operation. FIG. 3A shows the active power lines onboard the aircraft prior to docking. The onboard battery (e.g., 116), shown as battery (V2) port 210, can provide all of the power to the aircraft systems (e.g., 108). In this configuration, docking has not been achieved, and the aerial vehicle (e.g., 102) is about to transition to the charging vehicle (e.g., 104). In FIG. 3A, the controller 202 senses the battery (V2) 210 being available while the drogue power (V1) (208) is unavailable and thus connects (302) the battery (V2) 210 to the aircraft systems (e.g., 108) by enabling (304) the switch 142.

The controller 202 is configured to immediately switch powering the aircraft systems (e.g., 108) via the battery (e.g., 116) to the charging vehicle power supply 122 upon contact. In the unfortunate event of incomplete or intermittent connection issues, this system is passive and will continue to switch between the two sources of power. A passive system is beneficial for this reason. During the air-to-air refueling process, many different processes are happening simultaneously. By defining components and procedures to minimize the workload required of the autonomous system, a robust and adaptive air-to-air electrical energy transfer can be achieved.

Docked Connections. Upon the successful and sustained connection of the aerial vehicle (e.g., 102) and the charging vehicle (e.g., 104), the power to the aircraft systems (e.g., 108) is rerouted. FIG. 3B shows the aircraft system (e.g., 108) is powered by the charging vehicle power supply (e.g., 122) while the charging vehicle (e.g., 104) also charges the onboard battery (e.g., 116) of the aerial vehicle (e.g., 102). Because the circuitry is employing passive controls, the controller 202 can immediately switch due to any unintentional disconnects from the aircraft system (e.g., 108) to the aircraft battery (e.g., 116) without interruption.

Experimental Results and Examples

A study was conducted to evaluate the full air-to-air recharging scenario using the exemplary rapid electrical charging system 100. The charging study was conducted without risk to aircraft and without endangering the health of the Lithium Polymer(LiPo) battery inside of the tested UAS. The prior study also considered the use of the aircraft battery while simultaneously charging it but was rejected for circuit complexity concerns.

Experimental Method. The study included experiments using a simulated aerial vehicle and a charging vehicle. The simulated aerial vehicle includes a battery charging system and DC power supply. The DC power supply provided power to loads on the aircraft system. The DC power supply is then transitioned to the charging vehicle charger and disconnected from the aircraft battery. A prioritized power circuit corresponding to FIG. 2 was fabricated and employed for the experiments. The experiment was conducted on a 22.2V bus system for the aircraft's electrical power. A cruise amperage for the UAV was set to draw no more than 20A, which corresponds to a variety of fixed-wing electrically power UAS. An off-the-shelf LiPo battery charger was employed to simulate the charging vehicle charger (e.g., 104). The aircraft battery was simulated using a 6S LiPo battery. The LTC4418-UF Demo circuit from Linear Technology was employed to mimic the disconnection circuit (e.g., 120a).

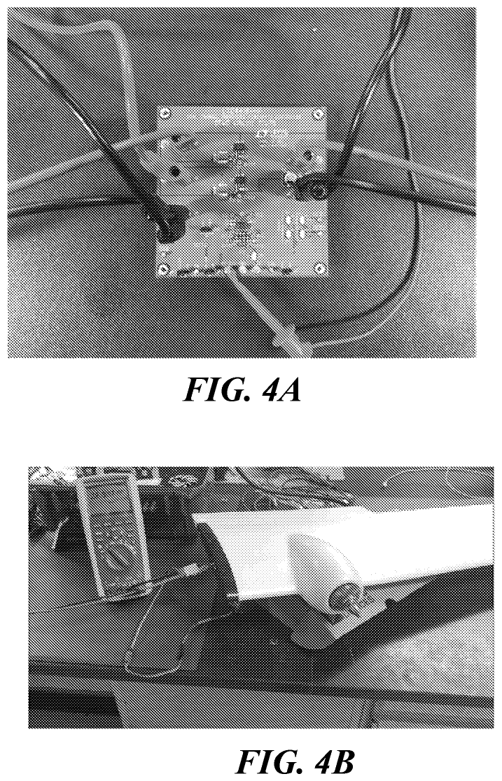

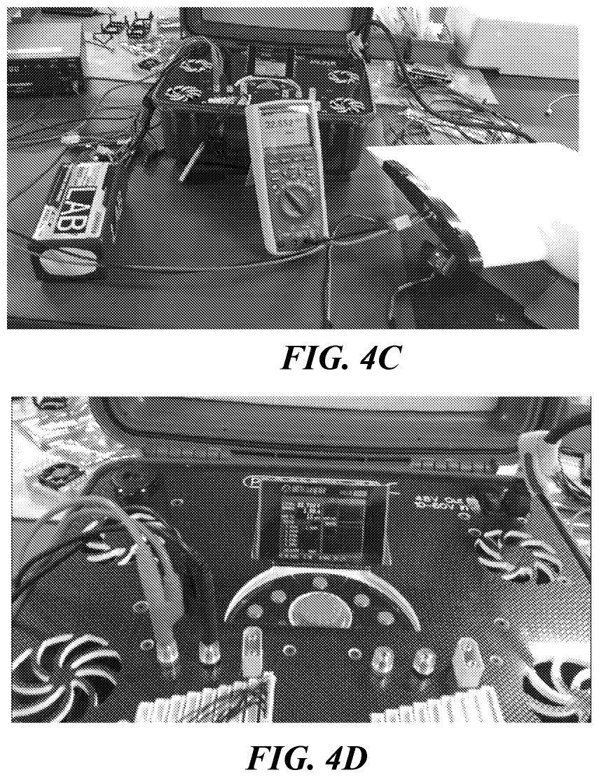

FIG. 4A shows an experimental setup comprising a disconnection circuit. This circuit connects two separate input power supplies to a common output. The circuit prioritizes the V1 and V2 inputs based on internal board prioritization and validity of the power supply, determined based on the voltages on each power supply. Different resistive loads were soldered to the board to evaluate different prioritized voltages representative for the simulated UAS system. The experiment employs a charging voltage of 22.537V.

The study was evaluated charging and transition on a UAV aircraft wing comprising a running motor to simulate no interruption in flight via the power switching operations. The full UDDER framework executes and tests all aspects of connection, charging, and disconnection while the aircraft motor is spinning. FIG. 4B shows the experimental setup comprising an UAV aircraft wing.

The typical air-to-air refueling procedure generally includes an acquisition, docking, refueling, and separation operation. Past studies have been conducted involving acquisition, docking, and separation. In [14], an investigation was conducted to evaluate an autonomous airborne docking system that included a guidance algorithm that operates with an infrared (IR) camera on a calf UAS and IR markers on a Cow UAS. The exemplary rapid electrical charging system 100 can be employed in conjunction with this docking operation, among others.

FIG. 4C shows the aircraft motor comprising a brushless motor under test to simulate operation in flight. A multimeter was used to display the voltage measured from the output connection of the disconnection circuit (e.g., 120a). During the test, the aircraft battery can provide all of the power to the aircraft systems, representing when the aerial vehicle is acquired and docking during a flight profile. The test then switches the charging vehicle power supply on, representing the initiation of the charging operation. The multimeter reading then provides the output voltage (see FIG. 4C).

Results and analysis. The results of this experiment showed (i) the successful transition of power between the aerial test vehicle and the test charging vehicle, and (ii) the successful transitioned of power back to the board battery power without power interruption to aircraft system operation. The voltages used in the experiment were selected to be a tight margin. The experiment was also conducted with voltages on the aerial vehicle power supply as high as 25.2V to verify operational capabilities. With the aircraft wing motor running, no discernible delay or interrupt was observed after performing multiple input power transitions. FIG. 4D shows the battery being actively charged at a constant current of 2 A, which was kept low for the test. Throughout this simulated disconnect process, the aircraft system was running without any interrupts.

### DISCUSSION

Manned aviation had always had to compromise the amount of fuel carried for the payload required. The solution to this trade-off came in the form of air to air refueling. Autonomous Aerial Refueling (AAR) was later demonstrated with the X-47b UCAS[7]. The X-47b is an Unmanned Aerial System (UAS) and with this achievement ushered in a new era of unmanned persistent operations for the United States Military. In addition to the increasing development of Group 3[13] and larger UAS's, the demand for smaller platforms has dramatically increased.

These smaller platforms lack the payload space for conventional internal combustion systems and are exclusively using electrical power plants. The technology responsible, Lithium-Ion batteries, which first hit the market in 1991[5]. Lithium-Ion batteries have revolutionized the way modern electronics are powered; yet for an aircraft, carrying the entirety of the battery for the entirety of the flight is inefficient. There is considerable interest and investment from the United States government involved in the fast and efficient recharging of autonomous drone swarms.

Persistent and quick re-launchable operations of sUAS and UAS have benefits. The exemplary system employs manned/liquid air-to-air refueling that is robust, lightweight, and readily adaptable high current electrical air-to-air recharging system.

Wireless charging. Wireless charging may not be practical for certain UVA applications, e.g., when minimizing Radio Frequency (RF) presence is desired. There are no quick-disconnect connectors and standardized mating apparatus for wireless charging.

Literature review. With the drone market expected to reach peaks of $100B in 2020[9], many companies and exhaustive research have focused on this market. While battery technology is a major limitation of current sUAS systems, this research has pivoted toward recharging systems for persistence and repeatable operations.

Wireless Charging Research: Much of the current solutions available for recharging UAS systems is through the use of wireless charging stations and inductive charging. As discussed in [2] the current approach is to use inductive charging stations and land the aircraft in order to begin energy replenishment. It was reported in [2] that the average recharge current is about 300 mA. While this was satisfactory for the scenario discussed in [2], as UAS gets larger and requires larger batteries, it is unclear if the technology can scale. Because fixed-wing UAS do not have to high fidelity positioning capabilities of a multi-rotor, the accuracy of inductance charging systems should be high to provide precise positioning of the UAS.

There are a variety of wireless charging systems available to the commercial UAS market currently. Skycharge manufactures the BOLOGNINI S1[10], and WiBotic manufactures a family of systems[12]. Both the Skycharge system and WiBotic are limited to a maximum power output of 500 W and 300 W, respectively. While this may be acceptable for low voltage applications, for higher voltages like 6S (22.2V), this becomes impractical for short recharge times.

The Skycharge and WiBotic Systems could provide 22A and 13A, respectively, to bring the system to full charge. In UAS systems today it is not uncommon to use 6S batteries of 22,000 mAh for larger commercial applications. In the cases of both of these systems, they require the drone to be completely stationary or hovering close enough to the recharging station for energy recovery to be practical. Both of these systems prove impractical for fixed-wing applications and require near stationary or stationary behavior of the UAS.

Autonomous Drones. The adoption of electrically powered drones has become widespread due to their simplicity, low-noise signature, and relatively small size when compared to internal combustion power-plant systems.

The compactness and simplicity enabled a relatively unique U AS configuration, the tube-launched configuration. A real-world example of this is the Raytheon Coyote [11], which would be impractical to design as an internal combustion UAS. It is this attractiveness for airborne electric platforms and widespread adoption that necessitates a fast, efficient, robust, and adaptable setup to recharge while in flight. UAS's are designed with a specific use case and built accordingly. In aerodynamics, there are a wide variety of trade-offs made depending on the flight envelope the aircraft is intended to operate in. The F/A-18 was designed to fulfill the roles of air superiority, fighter escort, close air support, and a variety of others [1]. These missions require a high level of maneuverability and speed, and the airframe itself is designed with that in mind. One notices the swept wings and sleek aerodynamic design characteristics improving the handling at higher speeds. While the F/A-18 was designed for speed and maneuverability, this negatively affects its fuel consumption. The F/A-18 establishes itself as a dominant force in the skies with its ability to refuel in-air. This in-air refueling capability gives the F/A-18 an on-station persistence that would be impossible otherwise. Due to autonomous in-air refueling still being relatively new, unmanned aircraft are designed with persistence in mind. The RQ-1 is an example of this.

A UAS primarily is often designed with slow speeds and persistence in mind. Without the requirement for high speeds, the design mostly comprises of a high-aspect-ratio wing most akin to manned glider aircraft and a fuel-efficient propulsion system. While the RQ-1 has a different mission set than the F/A-18, this is a byproduct of the sophistication level of autonomous systems during the adoption of the RQ-1 in the 1990's [8]. The sophistication of the autonomy available in the 1990's when the RQ-1 was first flown and then later used offensively in the early 2000's [8] dictated the mission sets available. The RQ-1 is primarily used today for reconnaissance and strategic strike platforms. These mission sets do not require the extreme speed or maneuverability that a fighter/interceptor aircraft possess.

Since UAS today lean toward electrical propulsion systems, they do not become lighter as they fly for longer, so flight optimization for a specific flight profile becomes even more crucial. By establishing an adaptable, robust, and fast air charging system, the rigidness of a UAS design becomes more relaxed.

Although example embodiments of the present disclosure are explained in some instances in detail herein, it is to be understood that other embodiments are contemplated. Accordingly, it is not intended that the present disclosure be limited in its scope to the details of construction and arrangement of components set forth in the following description or illustrated in the drawings. The present disclosure is capable of other embodiments and of being practiced or carried out in various ways.

It must also be noted that, as used in the specification and the appended claims, the singular forms “a,” “an” and “the” include plural referents unless the context clearly dictates otherwise. Ranges may be expressed herein as from “about” or “5 approximately” one particular value and/or to “about” or “approximately” another particular value. When such a range is expressed, other exemplary embodiments include from the one particular value and/or to the other particular value.

By “comprising” or “containing” or “including” is meant that at least the name compound, element, particle, or method step is present in the composition or article or method, but does not exclude the presence of other compounds, materials, particles, method steps, even if the other such compounds, material, particles, method steps have the same function as what is named.

In describing example embodiments, terminology will be resorted to for the sake of clarity. It is intended that each term contemplates its broadest meaning as understood by those skilled in the art and includes all technical equivalents that operate in a similar manner to accomplish a similar purpose. It is also to be understood that the mention of one or more steps of a method does not preclude the presence of additional method steps or intervening method steps between those steps expressly identified. Steps of a method may be performed in a different order than those described herein without departing from the scope of the present disclosure. Similarly, it is also to be understood that the mention of one or more components in a device or system does not preclude the presence of additional components or intervening components between those components expressly identified.

As discussed herein, a “subject” may be any applicable human, animal, or other organism, living or dead, or other biological or molecular structure or chemical environment, and may relate to particular components of the subject, for instance specific tissues or fluids of a subject (e.g., human tissue in a particular area of the body of a living subject), which may be in a particular location of the subject, referred to herein as an “area of interest” or a “region of interest.”

The term “about,” as used herein, means approximately, in the region of, roughly, or around. When the term “about” is used in conjunction with a numerical range, it modifies that range by extending the boundaries above and below the numerical values set forth. In general, the term “about” is used herein to modify a numerical value above and below the stated value by a variance of 10%. In one aspect, the term “about” means plus or minus 10% of the numerical value of the number with which it is being used. Therefore, about 50% means in the range of 45%-55%. Numerical ranges recited herein by endpoints include all numbers and fractions subsumed within that range (e.g., 1 to 5 includes 1, 1.5, 2, 2.75, 3, 3.90, 4, 4.24, and 5).

Similarly, numerical ranges recited herein by endpoints include subranges subsumed within that range (e.g., 1 to 5 includes 1-1.5, 1.5-2, 2-2.75, 2.75-3, 3-3.90, 3.90-4, 4-4.24, 4.24-5, 2-5, 3-5, 1-4, and 2-4). It is also to be understood that all numbers and fractions thereof are presumed to be modified by the term “about.”

The following patents, applications and publications as listed below and throughout this document are hereby incorporated by reference in their entirety herein.
[1] Federation of American Scientists. Military Analysis Network—F-18. URL: https://fas.org/man/dod-101/sys/ac/f-18.htm#::text=The%5C%20F%5C%2FA%5C%2D18%5C%20fills, day%5C%20and%5C%20night%5C%20strike%5C%20missions.
[2] C. H. Choi et al. “Automatic wireless drone charging station creating essential environment for continuous drone operation”. In: 2016 International Conference on Control, Automation and Information Sciences (ICCAIS). 2016, pp. 132-136. DOI: 10.1109/ICCAIS.2016.7822448.
[3] DARPA. AlphaDogfight Trials Foreshadow Future of Human-Machine Symbiosis. URL: http://www.darpa.mil/news-events/2020-08-26.
[4] United States Air Force. First Air-to-Air Refueling. URL: https://www.nationalmuseum.af.mil/Visit/Museum-Exhibits/Fact-Sheets/Display/Article/197385/first-air-to-air-refueling/#:_:text=The%5C%20first%5C%20successful%5C%20aerial%5C%20refueling %5C%20took%5C%20place%5C%20on%5C%20June%5C%2027,flyin%5C%20beneath %5C%20it%5C%20carrying%5C%20Lts.
[5] Nobel Foundation. Nobel Prize in Chemistry 2019: Lithium-ion batteries. URL: https://www.sciencedaily.com/releases/2019/10/191009082508.htm#:_:text=With20Goodenough's20cathode20as20a, oxide2C20can20intercalate20lithium20ions.
[6] Kris Holt. The US Army wants to build an autonomous drone charging system. URL: https://www.engadget.com/us-army-autonomous-drone-charging-system-161016972.html.
[7] Sam LaGrone. Navy Conducts Successful Test of Aerial Refueling with X-47B, UCAS-D Program Ending. URL: https://news.usni.org/2015/04/22/navy-conducts-successful-test-of-aerial-refueling-on-x-47b-ucas-dprogram-ending.
[8] John Pike. RQ-1 Predator MAE UAV. URL: https://fas.org/irp/program/collect/predator.htm.
[9] Goldman Sachs. Drones: Reporting for Work. URL: https://www.goldmansachs.com/insights/technologydriving-innovation/drones/#:_:text=Between%5C% 20now%5C%20and%5C%202020%5C%2C%5C% 20we, commercial%5C%20and%5C%20civil%5C% 20government%5C%20sectors.
[10] SkyCharge. BOLOGNINI S1. URL: https://skysenseweb-files.s3.amazonaws.com/Datasheet/BOLOGNINI+S1+-+20200728.pdf.
[11] Raytheon Technologies. Coyote UAS. URL: https://www.raytheconmissilesanddefense.com/capabilities/products/coyote.
[12] WiBotic. Technology. URL: https://www.wibotic.com/technology/.
[13] Wikipedia. U.S. military UAS groups. URL: https://en.wikipedia.org/wiki/U.S. military UAS groups.
[14] Daniel Wilson, Ali G\ddot{ }okto\check{ }gan, and Salah Sukkarieh. “Guidance and Navigation for UAV Airborne Docking”. In: July 2015. DOI: 10.13140/RG.2.1.1496.8162.
[15] US Publication No. 2018/0194466A1.

1. A method comprising:
providing a refueling harness from a charging aerial vehicle, the refueling harness comprising a first set of two or more conductors and a second set of two or more conductors that terminate at a set of open terminals on a drogue, wherein the first set of two or more conductors is configured to carry electrical energy to refuel one or more electrical energy storage components located on an aerial vehicle, and wherein the second set of two or more conductors is configured to carry electrical energy to electrical loads of the aerial vehicle;
connecting, via the drogue, over the first set of two or more conductors, a charger circuit of the charging aerial vehicle to a first electrical bus of the aerial vehicle that connects to the one or more electrical energy storage; and
connecting, via the drogue, over the second set of two or more conductors, a first power supply of the charging aerial vehicle to a second electrical bus of the aerial vehicle that connects to the electrical loads of the aerial vehicle.

2. The method of claim 1 further comprising:
sensing, by a sensing circuitry of the aerial vehicle, a connection between (i) two or more terminals of the second set of two or more conductors and (ii) second power supply of the aerial vehicle, wherein the second power supply connects to the electrical loads; and
disconnecting, by a power circuitry, based on the sensing, a third bus connection between (i) the second power supply located on the aerial vehicle and (ii) the one or more electrical energy storage.

3. The method of claim 2, wherein the second power supply of the aerial vehicle is connected to the one or more electrical energy storage of the aerial vehicle, and wherein electrical power is not drawn from the one or more electrical energy storage when the second electrical bus is disconnected.

4. The method of claim 2 further comprising:
sensing, by the sensing circuitry, a disconnection between (i) at least one of the two or more terminals of the second set of two or more conductors to terminals connected and (ii) the second power supply of the aerial vehicle; and
re-connecting, by the power circuitry, based on the sensing, the third electrical bus connecting between (i) the second power supply of the aerial vehicle and (ii) the electrical loads of the aerial vehicle.

5. The method of claim 1, further comprising:
sensing voltage level of individual cells of the onboard battery; and
balance charging one of more of the individual cells based on the sensing.

6. The method of claim 1, wherein the aerial vehicle is an unmanned aerial vehicle.

7. The method of claim 1, wherein the aerial vehicle is a terrestrial or surface/underwater-based vehicle.

8. A refueling harness for a charging aerial vehicle comprising:
a drogue that connects to an end of the refueling harness;
a first set of two or more conductors that terminate at a first set of open terminals on a drogue, wherein the first set of two or more conductors is configured to carry electrical energy from a charging circuit of the charging aerial vehicle to refuel one or more electrical energy storage components located on an aerial vehicle; and
a second set of two or more conductors that terminates at a second set of the open terminal on the drogue, wherein the second set of two or more conductors is configured to carry electrical energy from a first power supply of the charging aerial vehicle to electrical loads of the aerial vehicle,
wherein a second power supply of the aerial vehicle is connected to the one or more electrical energy storage of the aerial vehicle, and wherein electrical power of the one or more electrical energy storage of the aerial vehicle is not drawn from the one or more electrical energy storage when a first electrical bus is connected between the first set of two or more conductors and the one or more electrical energy storage components.

9. The refueling harness for a charging aerial vehicle of claim 8, further comprising:
a third set of a plurality of conductors that terminates at a third set of the open terminal on the drogue, wherein the third set of the plurality of conductors is configured to carry electrical energy from the second power supply individual cells of the one or more electrical energy storage of the aerial vehicle.

10. The refueling harness of claim 8, wherein a third bus connection is disconnected between (i) the second power supply located on the aerial vehicle and (ii) the one or more electrical energy storage when the aerial vehicle is electrically connected to the drogue.

11. The refueling harness of claim 10, wherein the third bus connection is disconnected by:
sensing, by a sensing circuitry of the aerial vehicle, a connection between (i) two or more terminals of the second set of two or more conductors to terminals connected and (ii) second power supply of the aerial vehicle; and
disconnecting, by a power circuitry, based on the sensing, a third bus connection between (i) the second power supply located on the aerial vehicle and (ii) the one or more electrical energy storage.

12. An aerial vehicle comprising:
one or more electrical energy storage components;
a first power supply configured to provide electrical energy to electrical loads of the aerial vehicle; and
a rapid electrical charging system comprising:
an electrical port configured to couple to an external refueling harness comprising a drogue while the aerial is in-flight;
a first set of two or more conductors that terminate at the electrical port, wherein the first set of two or more conductors is configured to carry electrical energy from a charging circuit of a charging aerial vehicle to refuel the one or more electrical energy storage components; and
a second set of two or more conductors that terminates at the electrical port, wherein the second set of two or more conductors is configured to carry electrical energy from a first power supply of the charging aerial vehicle to the electrical loads of the aerial vehicle, wherein a second power supply of the aerial vehicle is connected to the one or more electrical energy storage of the aerial vehicle, and wherein electrical power of the one or more electrical energy storage of the aerial vehicle is not drawn from the one or more electrical energy storage when the second set of two or more conductors is connected to the drogue.

13. The aerial vehicle of claim 12, further comprising a disconnection circuit configured to (i) sense, by a sensing circuitry of the aerial vehicle, a connection between (a) two or more terminals of the second set of two or more conductors and (b) second power supply of the aerial vehicle and (ii) disconnect, by a power circuitry, based on the sensing, a third bus connection between (a) the second power supply of the aerial vehicle and (b) the electrical loads of the aerial vehicle.

14. The aerial vehicle of claim 13, wherein the power circuitry comprises a switch that is one of a transistor, IGBT, MOSFET, or a combination thereof.

15. The aerial vehicle of claim 13, wherein the disconnection circuit is configured to isolate the one or more electrical energy storage components from the electrical loads of the aerial vehicle so as to prevent electrical power from being drawn from the one or more electrical energy storage.

16. The aerial vehicle of claim 13, wherein the disconnection circuit is configured to (i) sense, by the sensing circuitry, a disconnection between (a) at least one of the two or more terminals of the second set of two or more conductors to terminals connected and (b) the second power supply of the aerial vehicle and (ii) re-connect, by the power circuitry, based on the sensing, the third electrical bus.

17. The aerial vehicle of claim 13, wherein the disconnection circuit includes a first sensing circuit, a second sensing circuit, a first control output, and a second control output, wherein the first sensing circuit is configured to sense voltage at the second set of two or more conductors, wherein the second sensing circuit is configured to sense voltage at a bus connected to the one or more electrical energy storage components, and wherein the disconnection circuit is configured, by instructions or circuitry, to enable a switch via the second control output to connect the power supply of the charging aerial vehicle to the electrical loads of the aerial vehicle based on the first and second sensing.

18. The aerial vehicle of claim 17, wherein the disconnection circuit is configured to connect the power supply of the charging aerial vehicle to the electrical loads of the aerial vehicle when the voltage sensed at the second sensing circuit meets an overvoltage (OV) and under-voltage (UV) window for a pre-defined validation time.

19. The aerial vehicle of claim 17, wherein the disconnection circuit is configured to immediately (i) disconnect the third bus connection and (ii) connect the bus connected to the one or more electrical energy storage components when the voltage sensed at the second sensing circuit exceeds the overvoltage (OV) or the under-voltage (UV) window.

20. The aerial vehicle of claim 12, wherein the second power supply is configured to (i) sense voltage level of individual cells of the onboard battery and (ii) balance charge one of more of the individual cells based on the sensing.
